(19) United States
(12) Patent Application Publication
(10) Pub. No.: US 2025/0315053 A1
(43) Pub. Date: Oct. 9, 2025

(54) A METHOD OF LOCATING A CLEANING MACHINE

(71) Applicant: Nilfisk A/S, Copenhagen (DK)

(72) Inventors: Andrew Graham, Maple Grove, MN (US); Matt Stiehm, Northfield, MN (US)

(73) Assignee: Nilfisk A/S, Copenhagen (DK)

(21) Appl. No.: 18/866,159

(22) PCT Filed: May 17, 2023
(86) PCT No.: PCT/EP2023/063233

§ 371 Date: Nov. 15, 2024

Related U.S. Application Data
(60) Provisional application No. 63/343,185, filed on May 18, 2022.

(51) Int. Cl. G05D 1/246; A47L 9/28; A47L 11/40; G05D 1/617; G05D 1/648; G05D 105/10

(52) U.S. Cl. CPC G05D 1/246; A47L 9/2826; A47L 11/4011; G05D 1/617; G05D 1/6485; G05D 1/6486; A47L 2201/04; A47L 2201/06; G05D 2105/10

(57) ABSTRACT

A method of estimating a location of a cleaning machine include performing a mapping of a surrounding environment with an intelligence module of the cleaning machine. A path of the cleaning machine is recorded while the cleaning machine is in use. The cleaning machine is connected to a cloud computer. Data is shared from the cleaning machine with the cloud computer. At least one of a state of position, speed, acceleration, angular heading, a rate of rotation, a rate of acceleration, or a combination thereof of the cleaning machine is then estimated.

### TECHNICAL FIELD OF THE INVENTION

The present disclosure generally relates to cleaning machines. In particular, the present disclosure relates to a method of identifying a location of a cleaning machine.

### BACKGROUND OF THE INVENTION

Industrial and commercial floors are cleaned on a regular basis for aesthetic and sanitary purposes. There are many types of industrial and commercial floors ranging from hard surfaces, such as concrete, terrazzo, wood, and the like, which can be found in factories, schools, hospitals, and the like, to softer surfaces, such as carpeted floors found in restaurants and offices. Different types of floor cleaning equipment, such as vacuums, scrubbers, sweepers, and extractors, have been developed to properly clean and maintain these different floor surfaces.

Existing manual cleaning machines often lack features found in autonomous cleaning machines and platforms thereof. The lack of such features can increase the amount of time for cleaning a surface, use more water and energy with overall less efficiency with respect to cleaning material usage. The lack of features also adds difficulty in confirming cleaning activity has occurred.

The inventors have recognized that there is a need for an improved system that overcomes the aforementioned disadvantages.

### DESCRIPTION OF THE INVENTION

One aspect relates to a method of estimating a location of a cleaning machine that includes performing a mapping of a surrounding environment with an intelligence module of the cleaning machine. A path of the cleaning machine is recorded while the cleaning machine is in use. The cleaning machine is connected to a cloud computer. Data is shared from the cleaning machine with the cloud computer. At least one of a state of position, speed, acceleration, angular heading, a rate of rotation, a rate of acceleration, or a combination thereof of the cleaning machine is then estimated.

A second aspect relates to a method of cleaning with a cleaning machine that includes detecting at least one of a floor type, a soiled level, or a combination thereof of a floor with at least one of a sensor, an intelligence module, or a combination thereof of the cleaning machine. A cleaning setting is adjusted in response to at least one of the detected floor type, the detected soiled level, or the combination thereof. The cleaning machine is connected to a cloud computer. Data is shared from the cleaning machine with the cloud computer. The data shared with the cloud computer includes data representative of the detected floor type, the detected soiled level, or the combination thereof.

A third aspect relates to a method of estimating a position of a cleaning machine that includes processing a history of information of the cleaning machine with an intelligence module of the cleaning machine. An estimation of positions travelled by the cleaning machine is increased in response to the processed history of information. A map of the cleaning area is created with the intelligence modules.

A fourth aspect relates to a method of estimating a location of a cleaning machine adapted for manual operation, the method comprising:
mounting an intelligence module to a cleaning machine, or providing a cleaning machine with a pre-mounted intelligence module;
recording a path of the cleaning machine within a surrounding environment in which the cleaning machine is positioned, while the cleaning machine is in use;
performing, with the mounted intelligence module, a mapping of said surrounding environment;
storing collected data with said intelligence module;
connecting the cleaning machine and/or said intelligence module to a cloud computer;
sharing collected data from the cleaning machine and/or said intelligence module with the cloud computer; and
estimating, either with said intelligence module or with said cloud computer, at least the current location of said cleaning machine, including at least one of a state of position, speed, acceleration, angular heading, a rate of rotation, a rate of acceleration, or a combination thereof of the cleaning machine.

It should be noted that embodiments and features described in the context of one of the aspects of the present invention also apply to the other aspects of the invention.

### BRIEF DESCRIPTION OF THE FIGURES

FIG. 1 shows a flowchart of steps from of a method of estimating a location of a cleaning machine.

FIG. 2 shows another flowchart of additional steps of the method of estimating the location of the cleaning machine.

FIG. 3 shows another flowchart of additional steps of the method of estimating the location of the cleaning machine.

### DETAILED DESCRIPTION OF THE INVENTION

The present disclosure presents an opportunity to utilize autonomy concepts in manual cleaning machines, such as manual cleaning machine operating on a larger scale than autonomous cleaning machines are capable of. The present disclosure also helps with solving problems at scale providing additional benefits back to the higher tech platforms in autonomy reducing cost and increasing robustness of solutions.

The present disclosure provides an intelligence module for use with a cleaning machine. In an embodiment, the intelligence module can be an add-on module that can be retrofitted onto existing cleaning machines (e.g., manual cleaning machines) to bring e.g., artificial intelligence (“AI”) functionality and other features to any type of cleaning machine.

The intelligence module can be mounted to an external or internal surface of the cleaning machine. The intelligence module can be in communication with a control unit of the cleaning machine. The intelligence module can be in communication with a cloud server.

In an embodiment, the intelligence module can be connected to the control module of the cleaning machine via a wired connection, a wireless connection, or a combination thereof. Additionally, the intelligence module can include, be combined with, or used in connection with an inertial measurement unit (“IMU”), 2D and/or 3D camera(s), a light detection and ranging (“LIDAR”) device, a device configured to provide an odometry input (e.g., an odometer), or a combination thereof.

In an embodiment, a first configuration of the intelligence module contains a first set of sensors and a first amount of computing power. For example, the first configuration of the intelligence module can include one or more IMU's, a monocular camera, a wheel odometry device, WiFi, and/or Bluetooth. Additionally, one or more sensor readings from the first set of sensors can be combined or fused together using a filter, such as an Extended Kalman Filter, a Marginalized Particle Filter, or a combination thereof to estimate cleaning machines states of position, speed, acceleration and corresponding angular heading, rate of rotation, a rate of acceleration, or a combination thereof.

With such a first set of sensors, one or more estimated states may contain a high degree of error. In an embodiment, a neural network can be used to map a set of inputs (from the cleaning device, a user, or a combination thereof) over multiple cleaning cycles to a corrected output.

In another embodiment, a second cleaning machine (e.g., different in size from a first set of cleaning machines associated with the first set of sensors) can include a second configuration of a second intelligence module. The second intelligence module can enable increased computational power when combined with one or more sensors.

In another embodiment, a second cleaning machine can transmit data to a first cleaning machine. The first cleaning machine uses a neural network to map data from the first and second cleaning machines into a more accurate estimate of position.

In another embodiment, a first cleaning machine, a second cleaning machine, or a combination thereof transmits data to a cloud computer. The cloud computer uses a neural network to map data from the first cleaning machine, the second cleaning machine, or the combination thereof into a more accurate estimate of position. The cloud computer sends the more accurate position back to the first cleaning machine, the second cleaning machine, or the combination thereof.

In an embodiment, the position is a history of positions which show the path travelled by a cleaning machine.

In an embodiment, a second set of sensors used by the second intelligence module can include an image sensor such as a 2D camera, a 3D camera, or a combination thereof. For example, the 2D or 3D camera can create mapping in greater detail in environments including walls, floors, objects, and more.

In an embodiment, one or more cameras operably connected to the second cleaning machine, to the second intelligence module, or to a combination thereof, can extract landmarks from an area (e.g., a cleaning area) to determine what room the cleaning machine is in and apply a set of preselected cleaning settings, automatically calculate settings, or a combination thereof.

Additionally, the second intelligence module can use AI to analyze images to label a room type thereby adding context to resulting maps, e.g., terms such as “hallway” or “lobby”. Such classification(s) can provide context allowing for cleaning scheduling algorithms to determine how frequently to clean a space and allow system operators to instruct “clean the lobby” without the need for programming or changing settings.

In an embodiment, a set of sensors used by the intelligence module can include an image sensor such as a 2D camera, a 3D camera, or a combination thereof. A neural network can be used to create the segmentation and labelling of images separating the floor from walls, people, bollards, trashcans, and the like thereby allowing the cleaning machine to generate safety warnings or safety controls signals to prevent collisions. Additionally, labelling of images can prevent unintentional damage such as cleaning a carpeted area with water, or vacuuming up a can of soda. Creating the segmentation, labelling of images, or a combination thereof can also be done in combination with depth information given by a 3d camera or lidar. For example, a 2D image can be overlayed with depth information such that labeled objects can be perceived in 3D. Creating the segmentation, labelling of images, or a combination thereof can also be used so the cleaning machine can automatically limit (e.g., prevent from going above a maximum threshold value) the speed (and/or the acceleration) of the cleaning machine as the cleaning machine approaches certain objects (e.g., people, pets, or another labeled object).

In an embodiment, the second set of sensors can include a higher level of quality and accuracy than other sensors. In such an example, the second set of sensors with the higher quality and higher accuracy can enable accurate enough position tracking of second cleaning machine to indicate if the second cleaning machine is cleaning an area or sub-area more than once thereby saving time, water, energy, materials, costs, or a combination thereof. In an embodiment, the second intelligence module can provide an indication to an operator or user in the form of an alert to an operator, feedback to an operator (e.g., a supervisor) for cleaning machine training, as a driver assistant function causing the cleaning machine to slightly alter course, or a combination thereof.

In an embodiment, the first intelligence module, the second intelligence module, or a combination thereof can perform one or more of the follow steps. The intelligence module can perform mapping of a surrounding environment. The path of a cleaning machine can be recorded while in use. The presence of an object (e.g., non-human or human) can be detected. An impact with an object can be avoided (e.g., auto-stop). An operator can be assisted with the intelligence module in maximizing an amount of cleaning coverage of a floor. An operator can be assisted with the intelligence module in minimizing an amount of overlap in the cleaning area. A floor type of the cleaning area or the cleaned area can be detected. In an embodiment, the floor type can be detected by a sensor, the intelligence module, or a combination thereof. A soiled level of the cleaning area or cleaned area can be detected. In an embodiment, the soiled level can be detected by a sensor, the intelligence module, or a combination thereof.

Cleaning settings can be automatically adjusted. In an embodiment, the cleaning setting can be automatically adjusted in response to a detected floor type, a detected soiled-level, or a combination thereof. A cloud (e.g., a cloud-based storage and/or operating system) can be connected to and data can be uploaded, shared, or a combination thereof, with the set of data being representative of the soiled-level, floor type, or a combination thereof.

Cleaning paths can have error(s) due to sensor readings and processing by a computer. Data collected over different cleaning paths, at different times, can be combined to increase the understanding of the actual path, removing error.

An improvement of present disclosure is the modular nature of adding intelligence to a cleaning machine by way of an intelligence module. Existing autonomous platforms can perform some of the above stated actions but are typically required to fully integrate the actions into the systems of the cleaning machine. The present disclosure provides an add-on intelligence module that can be retrofitted to an existing cleaning machine with minimal setup and calibration. In addition, existing hardware (e.g., off-the-shelf 2d and 3d cameras) and computer platforms can be used to reduce the cost of the cleaning machine when compared with a fully autonomous system for a cleaning machine. In another embodiment, sensing and detection modalities can also be incorporated into the cleaning machines of the present disclosure.

Deploying the present disclosure to a plurality of manual cleaning machines can give access to a fleet larger than a focus just on development of automated cleaning machines. The manual fleet allows a great volume collection of data for development of AI and algorithm(s). Additional algorithms may be deployed with lower maturity than automated machines because the result of failure may not be critical to the function of the cleaning machine. In such an example, the quality and robustness of final solutions for both manual and automated cleaning can be improved.

The present disclosure allows for the collection of data, such as in the form of a usage map of where a cleaning machine was being used with the estimated efficiency and unique area cleaned, cleanliness data derived from actual sensor readings to prove the level of clean, usage reports that show how well the operator handled the cleaning machine (e.g., number of stops, percentage overlap, time to complete, or a combination thereof). The addition of such data available to an operator (e.g., product customer) can add value to the cleaning machine.

Additionally, an operator assist mechanism can be used in combination with the cleaning machine and/or the intelligence module to help avoid damage to equipment and to surrounding environments (e.g., facility or objects thereof), as well as helping to maximize the efficiency of the cleaning machine.

In another embodiment, data collected or produced according to the present disclosure can provide insights into usage and operator efficiency of the cleaning machine. In this and other embodiments, the collected data can allow an operator (e.g., the customer) to make informed decisions on how to get the most out of their cleaning machines and to be able to prove a level of cleanliness using data-driven methods. The present disclosure provides operator assist technologies that can save the customer money by ensuring cleaning machines and facilities stay undamaged and provide the most efficient cleaning methods, routes, and/or strategies available.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In an embodiment, the first intelligence module, the second intelligence module, or a combination thereof can perform one or more of the follow steps. The intelligence module can perform mapping (e.g., creation of a map) of a surrounding environment. The map can include the location of walls, doors, trashcans, and other stationary objects. The map also includes the history of estimated states of the cleaning machines position, velocity, acceleration, or a combination thereof. Additionally, or alternatively, a map can be created based on an outline of a building. In such an example, the outline of the building can be sensed, entered by a user, or a combination thereof.

In another embodiment, the created map can be updated, enhanced, adjusted, or a combination thereof over time as the first cleaning machine drives through the same area multiple times.

In another embodiment, the created map can be updated or enhanced over time as a second cleaning machine drives through the same area multiple times.

In an embodiment, an intelligence module can include a sensor to estimate the motion of a machine such as an IMU, wheel odometer, optical flow, or a combination thereof. Motion estimation can be integrated, processed in a filter, or otherwise manipulated to estimate the state or states of the cleaning machine. The states of the cleaning machine can include the history of position. The cleaning machine may drive through an area multiple times over multiple days, the history of such information can be processed using an AI algorithm or similar algorithm to increase the estimation of position(s) travelled. The position(s) of the machine can used to show the cleaned area.

In another embodiment, a second cleaning machine with an intelligence module can include a sensor to estimate the motion of a machine such as an IMU, wheel odometer, optical flow, or a combination thereof as the cleaning machine drives an area multiple times over multiple days. A history of information of a first cleaning machine, a second machine, or a combination thereof can combined using an AI algorithm or a similar algorithm to increase the estimation of position(s) travelled. The position(s) can used to show the cleaned area.

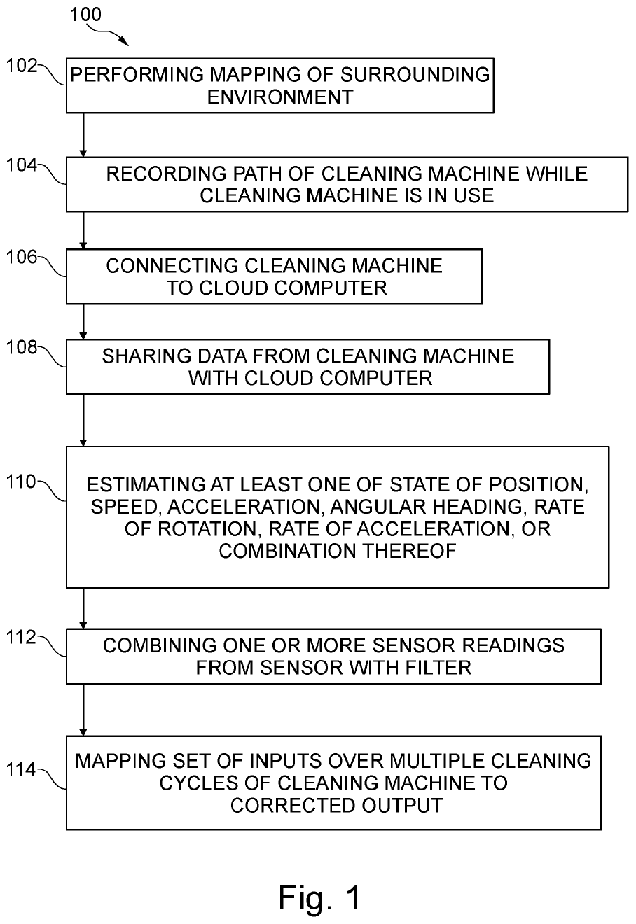

FIG. 1 shows a flowchart of steps from of method 100 of estimating a location of a cleaning machine. In particular, FIG. 1 shows steps 102 through steps 114 of method 100. In an embodiment, method 100 can include steps 102 to 170.

In an embodiment, the cleaning machine describe with respect to FIGS. 1-3 can include at least one of a first cleaning machine, a second cleaning machine, or a combination thereof. The first cleaning machine can include a first intelligence module with a first configuration and a first set of sensors. The second intelligence module can include a second set of sensors and a second intelligence module with a second configuration. The second set of sensors can include a two-dimensional camera, a three-dimensional camera, or a combination thereof. At least one of the first intelligence unit, the second intelligence unit or a combination thereof can includes at least one of an inertial measurement unit, a two-dimensional camera, a three-dimensional camera, a light detection and ranging device, an odometer, or a combination thereof.

Step 102 can include performing, with an intelligence module of the cleaning machine, a mapping of a surrounding environment. Step 104 can include recording a path of the cleaning machine while the cleaning machine is in use. Step 106 can include connecting the cleaning machine to a cloud computer. Step 108 can include sharing data from the cleaning machine with the cloud computer. Step 110 can include estimating at least one of a state of position, speed, acceleration, angular heading, a rate of rotation, a rate of acceleration, or a combination thereof of the cleaning machine. Step 112 can include combining, with a filter, one or more sensor readings from the sensor, wherein the filter comprises a kalman filter, a marginalized particle filter, or a combination thereof. Step 114 can include mapping, with a neural network, a set of inputs over multiple cleaning cycles of the cleaning machine to a corrected output, wherein the set of inputs are from the cleaning device, a user, or a combination thereof.

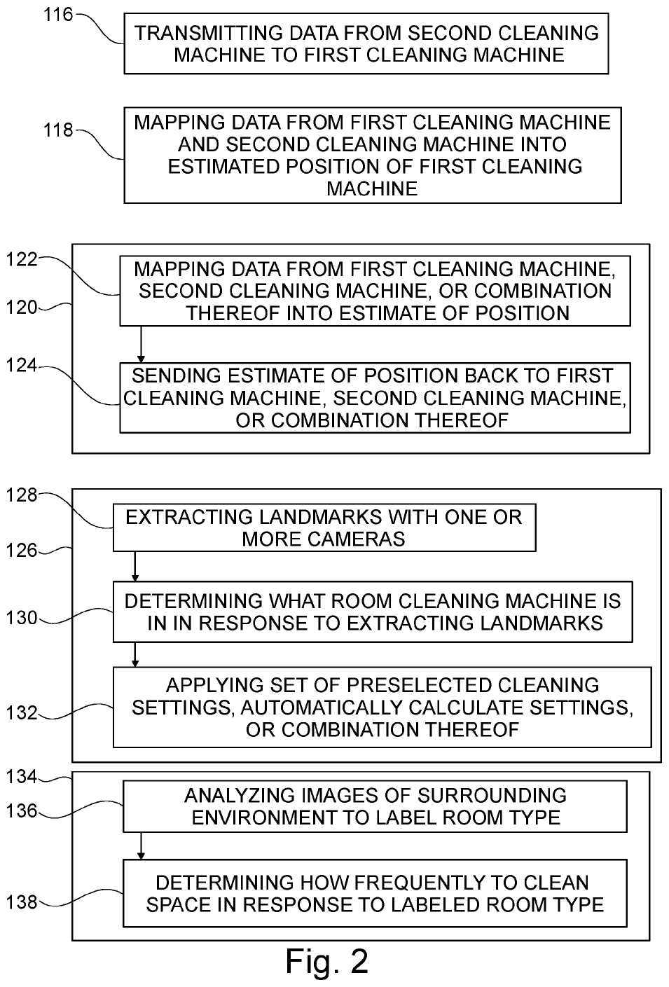

FIG. 2 shows another flowchart of steps 116 through 138 of method 100 of estimating the location of the cleaning machine. In an embodiment, method 100 can also include at least one of steps 116 through 138 or a combination thereof.

Step 116 can include transmitting data from the second cleaning machine to the first cleaning machine.

Step 118 can include mapping data, with a neural network, from the first cleaning machine and the second cleaning machine into an estimated position of the first cleaning machine.

Step 120 can include at least one of steps 122, 124, or a combination thereof. Step 122 can include mapping data from the first cleaning machine, the second cleaning machine, or the combination thereof into an estimate of a position. In an embodiment, the position can be a history of positions which show the path travelled by the cleaning machine. Step 124 can include sending the estimate of the position back to the first cleaning machine, the second cleaning machine, or the combination thereof.

Steps 126 can include at least one of steps 128, 130, 132, or a combination thereof. Step 128 can include extracting landmarks with one or more cameras operably connected to the cleaning machine, to the intelligence module, or to a combination thereof. Step 130 can include determining what room the cleaning machine is in in response to extracting landmarks. Step 132 can include applying a set of preselected cleaning settings, automatically calculate settings, or a combination thereof.

Step 134 can include at least one of steps 136, 138, or a combination thereof.

Step 136 can include analyzing images of the surrounding environment to label a room type with artificial intelligence. Step 138 can include determining how frequently to clean a space in response to the labeled room type.

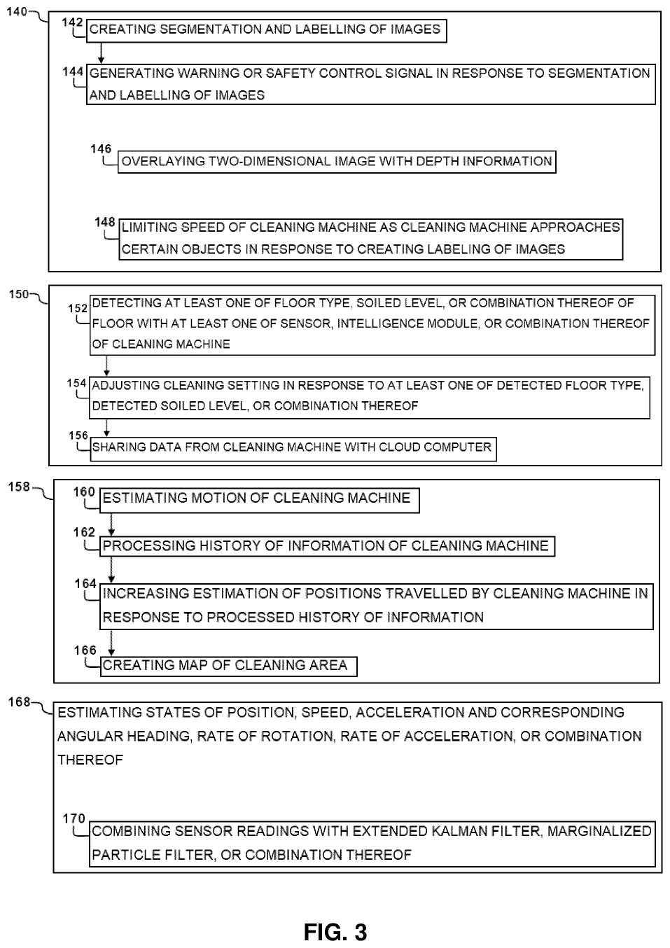

FIG. 3 shows another flowchart of steps 140 through 170 of method 100 of estimating the location of the cleaning machine. In an embodiment, method 100 can also include at least one of steps 140 through 170 or a combination thereof.

Step 140 can include at least one of steps 142, 144, 146, 148, or a combination thereof. Step 142 can include creating segmentation and labelling of images. Step 144 can include generating a warning or a safety control signal in response to the segmentation and labelling of images. Step 146 can include overlaying a two-dimensional image with depth information. Step 148 can include limiting the speed of the cleaning machine as the cleaning machine approaches certain objects in response to creating labeling of images.

Step 150 can include at least one of steps 152, 154, 156, or a combination thereof. Step 152 can include detecting at least one of a floor type, a soiled level, or a combination thereof of a floor with at least one of a sensor, an intelligence module, or a combination thereof of the cleaning machine. Step 154 can include adjusting a cleaning setting in response to at least one of the detected floor type, the detected soiled level, or the combination thereof. Step 156 can include sharing data from the cleaning machine with the cloud computer. In an embodiment, the data can include data representative of the detected floor type, the detected soiled level, or the combination thereof.

Step 158 can include at least one of steps 160, 162, 164, 166, or a combination thereof. Step 160 can include estimating, with a sensor, motion of the cleaning machine. Step 162 can include processing, with an intelligence module of the cleaning machine, a history of information of the cleaning machine. Step 164 can include increasing an estimation of positions travelled by the cleaning machine in response to the processed history of information. Step 166 can include creating, with the intelligence module, a map of the cleaning area.

Step 168 can include at least one of estimating, with Extended Kalman Filter, a Marginalized Particle Filter, or a combination thereof, states of position, speed, acceleration and corresponding angular heading, rate of rotation, a rate of acceleration, or a combination thereof of the cleaning machine, step 170, or a combination thereof. Step 170 can include combining sensor readings with an Extended Kalman Filter, a Marginalized Particle Filter, or a combination thereof.

### Various Notes & Examples

Example 1 can include or use subject matter such as a method of estimating a location of a cleaning machine, the method comprising: performing, with an intelligence module of the cleaning machine, a mapping of a surrounding environment; recording a path of the cleaning machine while the cleaning machine is in use; connecting the cleaning machine to a cloud computer; sharing data from the cleaning machine with the cloud computer; and estimating at least one of a state of position, speed, acceleration, angular heading, a rate of rotation, a rate of acceleration, or a combination thereof of the cleaning machine.

Example 2 can include or can optionally be combined with the subject matter of Example 1, to optionally include combining, with a filter, one or more sensor readings from the sensor, wherein the filter comprises a kalman filter, a marginalized particle filter, or a combination thereof.

Example 3 can include or can optionally be combined with the subject matter of one or any combination of Examples 1 or 2 to optionally include mapping, with a neural network, a set of inputs over multiple cleaning cycles of the cleaning machine to a corrected output, wherein the set of inputs are from the cleaning device, a user, or a combination thereof.

Example 4 can include or can optionally be combined with the subject matter of one or any combination of Examples 1-3 to optionally include a first cleaning machine comprising: a first intelligence module with a first configuration; and a first set of sensors; a second cleaning machine comprising: a second set of sensors; and a second intelligence module with a second configuration; and wherein the second cleaning machine comprises a second set of sensors comprising a two-dimensional camera, a three-dimensional camera, or a combination thereof.

Example 5 can include or can optionally be combined with the subject matter of one or any combination of Examples 1-4 to optionally include transmitting data from the second cleaning machine to the first cleaning machine.

Example 6 can include or can optionally be combined with the subject matter of one or any combination of Examples 1-5 to optionally include mapping data, with a neural network, from the first cleaning machine and the second cleaning machine into an estimated position of the first cleaning machine.

Example 7 can include or can optionally be combined with the subject matter of one or any combination of Examples 1-6 to optionally include mapping data from the first cleaning machine, the second cleaning machine, or the combination thereof into an estimate of a position, wherein the position is a history of positions which show the path travelled by the cleaning machine; and sending the estimate of the position back to the first cleaning machine, the second cleaning machine, or the combination thereof.

Example 8 can include or can optionally be combined with the subject matter of one or any combination of Examples 1-7 to optionally include extracting landmarks with one or more cameras operably connected to the cleaning machine, to the intelligence module, or to a combination thereof; determining what room the cleaning machine is in in response to extracting landmarks; and applying a set of preselected cleaning settings, automatically calculate settings, or a combination thereof.

Example 9 can include or can optionally be combined with the subject matter of one or any combination of Examples 1-8 to optionally include analyzing, with artificial intelligence, images of the surrounding environment to label a room type; and determining how frequently to clean a space in response to the labeled room type.

Example 10 can include or can optionally be combined with the subject matter of one or any combination of Examples 1-9 to optionally include creating segmentation and labelling of images; and generating a warning or a safety control signal in response to the segmentation and labelling of images.

Example 11 can include or can optionally be combined with the subject matter of one or any combination of Examples 1-10 to optionally include overlaying a two-dimensional image with depth information.

Example 12 can include or can optionally be combined with the subject matter of one or any combination of Examples 1-11 to optionally include limiting the speed of the cleaning machine as the cleaning machine approaches certain objects in response to creating labeling of images.

Example 13 can include or can optionally be combined with the subject matter of one or any combination of Examples 1-12 to optionally include wherein the intelligence unit comprises at least one of an inertial measurement unit, a two-dimensional camera, a three-dimensional camera, a light detection and ranging device, an odometer, or a combination thereof.

Example 14 can include or can optionally be combined with the subject matter of one or any combination of Examples 1-13 to optionally include a method of cleaning with a cleaning machine, the method comprising: detecting at least one of a floor type, a soiled level, or a combination thereof of a floor with at least one of a sensor, an intelligence module, or a combination thereof of the cleaning machine; adjusting a cleaning setting in response to at least one of the detected floor type, the detected soiled level, or the combination thereof; connecting the cleaning machine to a cloud computer; and sharing data from the cleaning machine with the cloud computer, wherein the data comprises data representative of the detected floor type, the detected soiled level, or the combination thereof.

Example 15 can include or can optionally be combined with the subject matter of one or any combination of Examples 1-14 to optionally include a method of estimating a position of a cleaning machine, the method comprising: estimating, with a sensor, motion of the cleaning machine; processing, with an intelligence module of the cleaning machine, a history of information of the cleaning machine; increasing an estimation of positions travelled by the cleaning machine in response to the processed history of information; and creating, with the intelligence module, a map of the cleaning area.

Example 16 can include or can optionally be combined with the subject matter of one or any combination of Examples 1-15 to optionally include estimating, with Extended Kalman Filter, a Marginalized Particle Filter, or a combination thereof, states of position, speed, acceleration and corresponding angular heading, rate of rotation, a rate of acceleration, or a combination thereof of the cleaning machine.

Example 17 can include or can optionally be combined with the subject matter of one or any combination of Examples 1-16 to optionally include combining sensor readings with an Extended Kalman Filter, a Marginalized Particle Filter, or a combination thereof.

Each of these non-limiting examples can stand on its own or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In one or more embodiments, the cleaning machine or said intelligence module comprises one or more sensors, wherein the method further comprises combining, with a filter, one or more sensor readings from the one or more sensors, wherein the filter comprises a kalman filter, a marginalized particle filter, or a combination thereof.

In one or more embodiments, the method further comprises:
mapping, with a neural network, implemented in said intelligence module and/or in said cloud computer, a set of inputs over multiple cleaning cycles of the cleaning machine to a corrected output, wherein the set of inputs are from the cleaning device and/or said intelligence module, a user, or a combination thereof.

In one or more embodiments, the method comprises utilizing:
a first cleaning machine comprising:
i) a first intelligence module with a first configuration; and
ii) a first set of sensors; and
a second cleaning machine comprising:
i) a second set of sensors; and
ii) a second intelligence module with a second configuration; and wherein said second cleaning machine is used to collect data for use in estimating the position of said first cleaning machine.

In one or more embodiments, the second set of sensors comprises a two-dimensional camera, a three-dimensional camera, or a combination thereof.

In one or more embodiments, the method further comprises:
transmitting collected data from the second cleaning machine to the first cleaning machine and/or to the cloud computer.

In one or more embodiments, the method further comprises:
mapping data, with a neural network implemented in said intelligence module(s) and/or in said cloud computer, collected from the first cleaning machine and the second cleaning machine into an estimated position of the first cleaning machine.

In one or more embodiments, the method further comprises:
mapping data, with said cloud computer, collected from the first cleaning machine, the second cleaning machine, or a combination thereof into an estimate of a position of said first cleaning machine, wherein the position is a history of positions, which show the path travelled by the first cleaning machine; and
sending the estimate of the position back to the first cleaning machine, the second cleaning machine, or to both cleaning machines.

In one or more embodiments, the method further comprises:
extracting landmarks with one or more cameras operably connected to the cleaning machine and/or to the intelligence module;
determining what room, the cleaning machine is positioned in, in response to said extracted landmarks; and
in response to said determination, applying a set of predetermined cleaning settings, automatically calculated cleaning settings, or a combination thereof.

In one or more embodiments, the method further comprises:
analyzing, with said intelligence module and/or said cloud computer, preferably with artificial intelligence, received images of the surrounding environment to label/identify a room type; and
determining how frequently to clean a space in response to the labeled/identified room type.

In one or more embodiments, the method further comprises:
creating segmentation and labelling of images with said intelligence module and/or said cloud computer; and
generating a warning or a safety control signal in response to the segmentation and labelling of images.

In one or more embodiments, the process of creating segmentation and labelling of images comprises overlaying a two-dimensional image with depth information.

In one or more embodiments, the method further comprises:
limiting the maximum speed of the cleaning machine as the cleaning machine approaches certain objects in response to the operation of segmentation and labeling of images.

In one or more embodiments, the intelligence unit comprises a sensor selected from at least one of an inertial measurement unit, a two-dimensional camera, a three-dimensional camera, a light detection and ranging device, an odometer, or a combination thereof.

In one or more embodiments, the method further comprises:
detecting at least one of a floor type, a soiled level, or a combination thereof of a floor with at least one of a sensor, an intelligence module, or a combination thereof of the cleaning machine;
adjusting a cleaning setting in response to at least one of the detected floor type, the detected soiled level, or the combination thereof; and
sharing collected data from the cleaning machine with the cloud computer, wherein the data comprises data representative of the detected floor type, the detected soiled level, or the combination thereof.

In one or more embodiments, the method further comprises:
estimating, with a sensor, the motion of the cleaning machine;
processing, with an intelligence module of the cleaning machine, a history of information of the cleaning machine;
improving or correcting an estimation of positions travelled by the cleaning machine in response to the processed history of information; and
creating, with the intelligence module, a map of the cleaning area.

In one or more embodiments, the method further comprises:
estimating, with Extended Kalman Filter, a Marginalized Particle Filter, or a combination thereof, at least the current location of said cleaning machine, including at least states of position, speed, acceleration and corresponding angular heading, rate of rotation, a rate of acceleration, or a combination thereof of the cleaning machine.

In one or more embodiments, the process of estimating the current location, states of position, speed, acceleration and corresponding angular heading, rate of rotation, a rate of acceleration, or a combination thereof of the cleaning machine comprises combining sensor readings with an Extended Kalman Filter, a Marginalized Particle Filter, or a combination thereof.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of estimating a location of a cleaning machine adapted for manual operation, the method comprising:
providing a cleaning machine including an intelligence module;
recording a path of the cleaning machine within a surrounding environment in which the cleaning machine is positioned, while the cleaning machine is in use;
performing, with the intelligence module, a mapping of the surrounding environment;
storing collected data with the intelligence module;
connecting the cleaning machine to a cloud computer;
sharing at least a portion of the collected data with the cloud computer; and
estimating, either with at least one of the intelligence module and the cloud computer, at least a current location of the cleaning machine, including at least one of a state of position, speed, acceleration, angular heading, a rate of rotation, a rate of acceleration, or a combination thereof of the cleaning machine.

2. The method of claim 1, wherein the cleaning machine further comprises one or more sensors, wherein the method further comprises combining, with a filter, one or more sensor readings from the one or more sensors, wherein the filter comprises least one of a kalman filter, a marginalized particle filter, and a combination thereof.

3. The method of claim 1, further comprising:
mapping, with a neural network, implemented in at least one of the intelligence module and the cloud computer, a set of inputs over multiple cleaning cycles of the cleaning machine to a corrected output, wherein the set of inputs are from at least one of the cleaning device, the intelligence module, and a user.

4. The method of claim 1, wherein the method comprises utilizing:
a first cleaning machine comprising:
i) a first intelligence module with a first configuration; and
ii) a first set of sensors; and
a second cleaning machine comprising:
i) a second set of sensors; and
ii) a second intelligence module with a second configuration; and
wherein the second cleaning machine is used to collect data for use in estimating the position of the first cleaning machine.

5. The method of claim 4, wherein the second set of sensors comprises at least one of a two-dimensional camera and a three-dimensional camera.

6. The method of claim 4, further comprising transmitting collected data from the second cleaning machine to at least one of the first cleaning machine and the cloud computer.

7. The method of claim 4, further comprising:
mapping data, with a neural network implemented in at least one of the first intelligence modules, the second intelligence module, and the cloud computer, collected from the first cleaning machine and the second cleaning machine into an estimated position of the first cleaning machine.

8. The method of claim 4, further comprising:
mapping data, with the cloud computer, collected from at least one of the first cleaning machine and the second cleaning machine, into an estimate of a position of the first cleaning machine, wherein the position is a history of positions, which show the path travelled by the first cleaning machine; and
sending the estimate of the position back to at least one of the first cleaning machine and the second cleaning machine.

9. The method of claim 1, further comprising:
extracting landmarks with one or more cameras operably connected to the cleaning machine;
determining what room, the cleaning machine is positioned in, in response to the extracted landmarks; and
in response to said determination, applying at least one of a set of predetermined cleaning settings; and automatically calculated cleaning settings.

10. The method of claim 1, further comprising:
analyzing, with at least one of the intelligence module and the cloud computer, received images of the surrounding environment to label/identify a room type; and
determining how frequently to clean a space in response to the labeled/identified room type.

11. The method of claim 1, further comprising:
creating segmentation and labelling of images with at least one of the intelligence module and the cloud computer; and
generating at least one of a warning and a safety control signal in response to the segmentation and labelling of images.

12. The method of claim 11, wherein the process of creating segmentation and labelling of images comprises overlaying a two-dimensional image with depth information.

13. The method of claim 11, further comprising:
limiting a maximum speed of the cleaning machine as the cleaning machine approaches certain objects in response to the operation of segmentation and labeling of images.

14. The method of claim 1, wherein the intelligence unit comprises a sensor selected from a group consisting of an inertial measurement unit, a two-dimensional camera, a three-dimensional camera, a light detection and ranging device, and an odometer.

15. The method of claim 1, further comprising:
detecting at least one of a floor type, a soiled level, and a combination thereof of a floor with at least one of a sensor, the intelligence module, and a combination thereof of the cleaning machine;
adjusting a cleaning setting in response to at least one of the detected floor type, the detected soiled level, and the combination thereof; and
sharing collected data from the cleaning machine with the cloud computer, wherein the data comprises data representative of at least one of the detected floor type, the detected soiled level, and the combination thereof.

16. The method of claim 1, further comprising:
estimating, with a sensor, motion of the cleaning machine;
processing, with an intelligence module of the cleaning machine, a history of information of the cleaning machine;
at least one of improving and correcting an estimation of positions travelled by the cleaning machine in response to the processed history of information; and
creating, with the intelligence module, a map of the cleaning area.

17. The method of claim 16, further comprising:
estimating, with at least one of an Extended Kalman Filter, a Marginalized Particle Filter, and a combination thereof, at least the current location of the cleaning machine, including at least states of position, speed, acceleration and corresponding angular heading, rate of rotation, and a rate of acceleration of the cleaning machine.

18. The method of claim 17, wherein the process of estimating the current location, states of position, speed, acceleration and corresponding angular heading, rate of rotation, and the rate of acceleration of the cleaning machine comprises combining sensor readings with at least one of an Extended Kalman Filter, a Marginalized Particle Filter, and a combination thereof.
